(19) United States
(12) Patent Application Publication
(10) Pub. No.: US 2012/0160888 A1
(43) Pub. Date: Jun. 28, 2012

(54) FASTENER DRIVING APPARATUS

(75) Inventor: Ulrich SCHIESTL, Hohenems (AT)

(73) Assignee: Hilti Aktiengessellschaft, Schaan (IL)

(21) Appl. No.: 13/329,406

(22) Filed: Dec. 19, 2011

(30) Foreign Application Priority Data
Dec. 22, 2010 (DE) 102010063964.8

(51) Int. Cl. B25C 1/06

(52) U.S. Cl. 227/8

(57) ABSTRACT

A fastener-driving apparatus is provided comprising a mechanical storage means with a tensioning device driven via a rotatable shaft, where release of the stored mechanical energy drives a driving ram, a drive arrangement with an electric motor to introduce mechanical energy into the energy storage means by driving the shafts in a tensioning direction, and a locking coupling arranged between the motor and the tensioning device and having an input shaft and an output shaft, where the tensioning device is kept self-locking by the locking coupling in at least one pretensioned position when the motor is shut off, and where the locking coupling has at least one locking element that can be wedged against an active surface, where the locking element is releasable from a wedged position by means of a rotation of the input shaft against the tensioning direction by a specific amount of travel (H).

The invention concerns a fastener-driving apparatus according to the generic part of Claim 1.

WO 2007/142997 A2 describes a spring-actuated nailer, in which a mechanical energy storage means in the form of a coil spring is brought into a pretensioned position by means of a motor-driven spindle. A driving ram is triggered to drive a nail element by means of the spring-actuated nailer due to the fact that the driving ram becomes further tensioned from the pretensioned position by the motor against an end position, where bumping at the end position releases the driving ram. Relieving the tension of the helical coil from the pretensioned position while the motor turns in the reverse direction is prevented by a locking clutch. If the spring-actuated nailer is shut down the pretension helical spring is released by rotating the motor against the tensioning direction. Because of the design of the rotary coupling, when the driveshaft rotates in the reverse direction, grinding of the coupling in which friction and heat energy is generated within the coupling takes place.

It is the task of the invention to specify a driving apparatus that has improved reliability using simple means.

This task is solved in accordance with the invention for a fastener-driving apparatus of the kind mentioned above with the characterizing features of Claim 1. Through the release of the locking element, preferably by a specific amount of travel, from the wedged position a possible grinding or chattering interaction of the locking element with the active surface, as may otherwise be the case, in particular with unintentional releases of the locking element from a wedging position, will be avoided. Through this, excess friction of the locking element against the active surface is prevented, so that the energy held in the energy storage means is not converted, or [is converted] only minimally, to heat energy within the locking coupling. In particular, grinding of the locking element in the active surface is reduced or entirely prevented, so that the lifetime of the locking coupling is possibly increased.

Because the locking element can be released from a wedged position with the input shaft torque-loaded in the tensioning direction, it is in particular possible to convert most of or all of the energy of the pretensioned energy storage means to heat, or even usable stored electric energy via the motor and load resistors that are optionally connected with it, while avoiding mechanical friction. The electric motor is driven by the mechanical storage means and the tensioning device and functions as a generator, and the locking coupling is in a released and nongrinding state, in particular a state specifically defined therefor.

Generally advantageously, the energy storage means is made as a spring, preferably, but not necessarily, as a coil spring. In alternative embodiments it can, however, also be a gas pressure storage means (gas spring) or the like. Further advantageously, the tensioning device can be made as a spindle. Especially preferably, the spindle has a ball nut, through which particularly little friction arises. In each case according to the detailed design, the electric motor can drive the spindle or the ball nut, in order, for example, to convert the rotary motion to linear motion so as to tension the energy storage means.

In a generally advantageous embodiment of the invention the driving ram can be released by moving the tensioning device from the pretensioned position into an end position. In combination with the locking coupling this is an advantageous embodiment, in which additional keeper elements such as a releasable pawl, can be omitted. The triggering of the driving ram in movement to the end position can take place in a simple known way, for example by a keeper element holding the driving ram being released at a sliding stop in the end position

Especially preferably, it is provided that when the driving apparatus is switched off, a controlled release of tension of the energy storage means is at least initiated by a movement of the motor against the tensioning direction. At least the tensioning operation can take place by movement of the motor merely by a relatively small angle of rotation, through which the locking coupling of the design in accordance with the invention is specifically released and the remaining operation of untensioning of the mechanical storage means can run mechanically self-controlled. The untensioning operation can also, however, be supported in a controlled way by running the electric motor in the direction of releasing the tension of the mechanical energy storage means in a controlled way via a suitable electronic control and, in so doing, contribute a braking effect, particularly in generator operation. Systems known from the prior art make it necessary each time that the motor be driven in the untensioning direction, since the traditional locking couplings do not have a specific released state in which they remain and enable self-actuating untensioning without running the motor in the untensioning direction. It is provided in a detailed design of the invention that the locking coupling at least comprises a lever element that can be moved with respect to the input shaft and the output shaft, where a position of the locking element relative to the active surface can be changed by movement of the lever element. Through this the locking element can be brought in a particularly simple way to a specified distance (specified travel) with respect to the active surface, so that renewed grinding or chattering intermeshing of locking element and active surface is avoided.

In a preferred embodiment the lever element is made as a rotatably mounted rocker arm, through which a mechanically simple and reliable release is made available.

In another advantageous detailed design the rocking element can be movable by rotation of the input shaft relative to the output shaft, where an active surface of the lever element interacts with a cam surface of the input shaft. In particular, with such a simple mechanical release the cam surface can be designed so that a is present above the dead point position with respect to the lever element, so that the locking coupling remains in a specific released state as long as a sufficiently large rotary moment of the shaft is not applied in the tensioning direction or no new tensioning operation is begun by the electric motor.

Generally advantageously, it is provided that the input shaft and the output shaft interlock with each other in a form fit in the direction of rotation, where the inner lock has play by a specific angle of rotation. Through the form-fit interlock, simple transmission of as large a torque as one wishes is enabled, and the play by a specific angle of rotation enables actuation of the locking coupling in a simple way. In an especially preferred detailed design it is provided that the form-fit interlock is arranged in the axial direction in a different plane from the locking element. This enables simple construction of the locking coupling, where in particular a relatively small maximum diameter of the locking coupling for given requirements on the torque to be transmitted is enabled.

Other advantages and features of the invention result from the embodiment example described below and from the dependent claims.

A preferred embodiment example of the invention is described below and explained in more detail by means of the attached drawings.

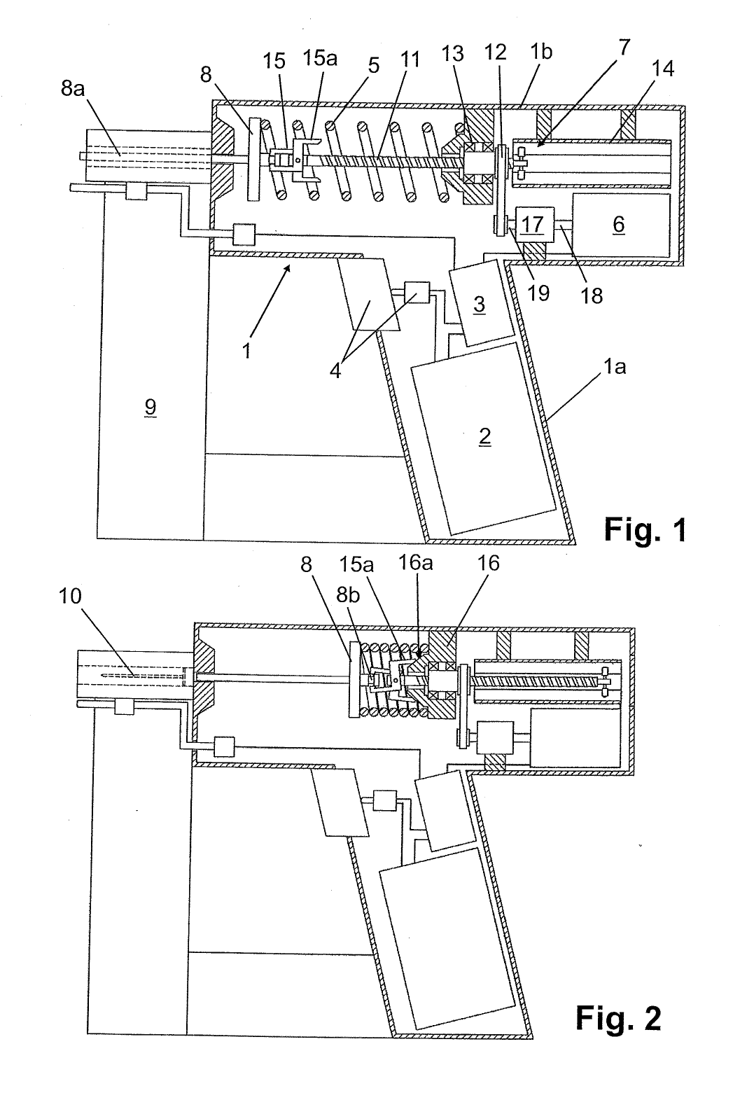

FIG. 1 shows a schematic cross section of a driving apparatus in accordance with the invention in untensioned position.

FIG. 2 shows the driving apparatus from FIG. 1 in a fully tensioned position at the moment of triggering it.

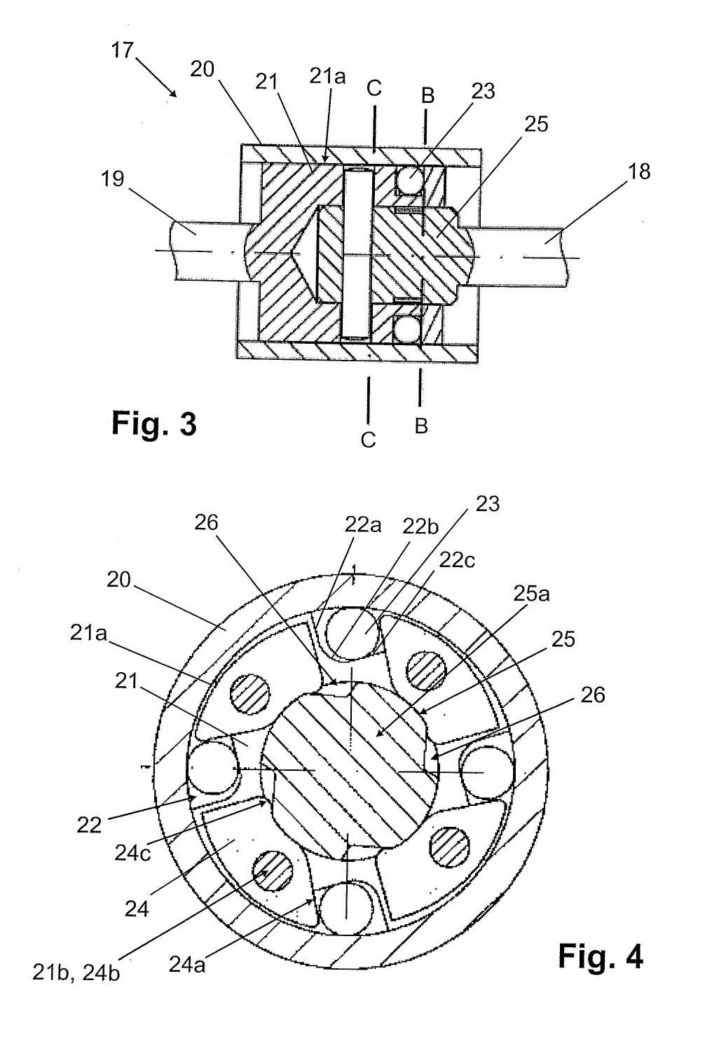

FIG. 3 shows an axial cross section through a locking coupling of the driving apparatus.

FIG. 4 shows the locking coupling from FIG. 3 in a sectional view through line B-B in locked position.

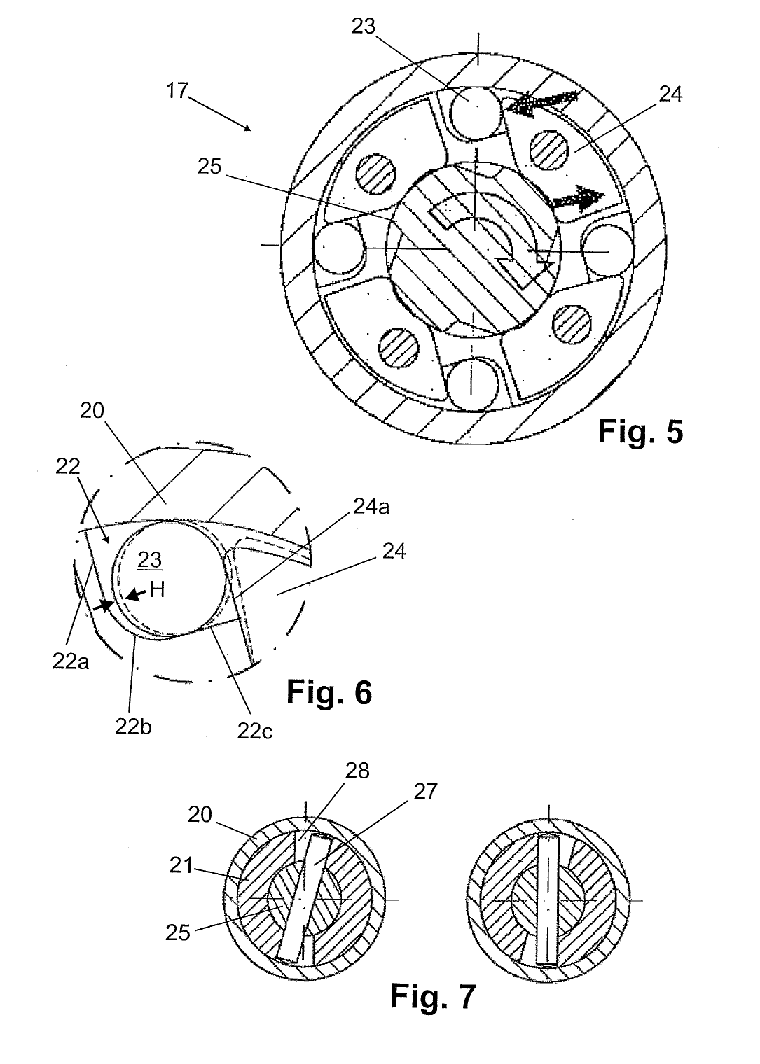

FIG. 5 shows the view from FIG. 4 in released position.

FIG. 6 shows a detailed enlargement of the locking coupling from FIGS. 4 and 5.

FIG. 7 shows the locking coupling from FIG. 3 in a cross section through line C-C in two different stop positions.

The hand-operated fastener-driving apparatus shown in FIG. 1 has a housing 1 with a handle 1a, in which an electrical energy storage means 2, a control electronics unit 3 and an electrical actuating switch 4 are accommodated. In an upper part of the housing 1b a mechanical energy storage means 5 in the form of a coil spring, an electrical motor 6 and a tensioning device 7 are accommodated. At the front end of the coil spring 5 there is a driving ram 8, which can drive a nail or fastening pin 10 that is loaded from a magazine 9 into a workpiece by means of a pin 8a.

The tensioning device 7, which converts rotation of electric motor 6 to tensioning of coil spring 5, comprises a threaded spindle 11, which can be rotated by a drive belt 12 and is held in a ball nut 13 that is fixed in position in housing 1. Spindle 11 is additionally led into guide housing 14 in a rear section of the upper housing 1b. Bracket 15, which can mesh into a correspondingly shaped formation 8b on the driving ram 8 is present at the front end of spindle 11. Bracket 15 is spring-loaded, so that both in the untensioned state shown in FIG. 1, as well as in all states of pretensioning, bracket 5 interlocks with the driving ram 8 in a form fit.

Triggering the driving ram 8 by a release via bracket 15 takes place by moving spindle 11 to an end position or by a completely tensioned position of coil spring 5. In this end position, which is shown in FIG. 2, bracket 15 is opened by stopping at a thrust bearing 16 formed with conical surface 16a, where the projecting ends 15a of the bracket are brought against the conical surface 16a and slide on it into an open position.

In addition, between motor 6 and spindle 11 there is provided a locking coupling 17, which keeps spindle 11, when the motor is shut off in a pretensioned position of coil spring 5, from independently rotating in the reverse direction due to the force applied by the coil spring 5.

The locking coupling 17 in this case is arranged between motor 6 and a drive-side wheel of the belt drive 19 of spindle 11. The locking coupling 17 is supported on housing 1 and has an input-side shaft 18, which goes from motor 6 to locking coupling 17, and an output-side or drive-side shaft 19, which goes from locking coupling 17 to the drive-side belt wheel of belt drive 12.

The construction and function of locking coupling 17 are shown in detail in FIGS. 3-7. Locking coupling 17 has a casing 20, which is solidly connected to housing 1 of the driving apparatus. Casing 20 has a hollow cylindrical recess, in which a drive-side seal 21, which is firmly joined to the output shaft 19, is accommodated. The drive-side seal 21 has an external cylindrical circumferential wall 21a, at least in sections, which is held in the hollow cylindrical casing wall 20 in a way so that it can slide. In circumferential wall 21a there is provided at least one recess 22, in this case exactly for recesses 22 that are symmetrically arranged 90° apart. A locking element in the form of a ball 23 is accommodated in each of recesses 22.

Recess 22 begins as wall 22a that is nearly perpendicular to outer surface 21a and has an inwardly radial course, after which it becomes a bottom surface 22c after a bending region 22b. Bottom surface 22c is slightly tilted with respect to a tangent, where the bottom surface in FIG. 4 rises radially outward in the clockwise direction.

Through this, each of bottom surface 22c on the one hand, and the inner surface of the hollow cylindrical casing wall 20 on the other, forms an active surface, between which the ball 23, or the locking element, can wedge with the appropriate rotation of seal 21 relative to casing 20. In FIG. 4 this would take place if the seal, or the drive-side or output-side shaft 19, were rotated counterclockwise with respect to the fixed casing 20. With the opposite rotation in clockwise direction (=tensioning rotation direction or tensioning direction), no wedging and thus no locking of the coupling by balls 23 would take place, the balls would move in the direction of the radially traveling wall 22a, where the distance between the limiting surfaces of recess 22 and the inner cylindrical surface of casing 20 is large enough to hold the balls 23 without wedging.

A limitation for movement of locking element 23 acting in the circumferential direction and lying opposite radial walls 22a is provided in each case by the active face 24a of a lever element 24 that is formed as a rocker arm. Rocker arm 24 is made, for example, as a plate-shaped sheet metal part. It has a drilling 24b, in which a projecting round pin 21b of seal 21 fits in the axial direction, so that the rocker can swivel about the pin. Besides the active face 24a, an active surface 24c, which projects radially inwardly as a kind of cam, is formed on the rocker arm 24.

A central region of seal 21 has a cylindrical through-hole, in which a head 25 of the input-side or drive-side shaft 18 fits. Head 25 is firmly bonded to shaft 18 and in particular can be made integrally with it. Head 25 has a substantially cylindrical circumference, with four axially running recesses 26 being provided in the circumference of head 25. The parts 25a of head 25 that project beyond recesses 26 form cam surfaces of the input shaft or head 25. The cam surfaces have the shape of a cylinder section, so that the head slides smoothly into the central through-hole of seal 21 by means of the cam surfaces.

In the locked position as in FIG. 4, in which, for example, a rotary moment is applied to seal 21 counterclockwise (reversing force of coil spring 5 via spindle 11), the locking elements 23 are wedged between bottom surface 22c and the inner circumference of casing 20. Through this, counterclockwise rotation of seal 21 is prevented. The lever elements 24 are all in unactuated or released position, and the cam-like active surfaces 24c protrude into the recesses 26 of head 25. Even though in the drawing in FIG. 4 the balls 23 presumably contact the active faces 24a of lever elements 24, in this position there is nevertheless not a force locked connection between the balls 23 and the lever elements 24. In this regard see the detailed presentation in FIG. 6.

In contrast, FIG. 5 shows a position of the locking coupling 17, in which all of the balls or locking elements 23 are related. For this, head 25 is rotated clockwise relative to seal 21 by a specific angle, for example about 5°. The cam surfaces 25a that project beyond the recesses 26 engage into the cam-like active surfaces 24c of lever elements 24, so that they are swiveled counterclockwise by a small angle about their bearing, or pins 21b. Through this, balls 23 are moved via the active faces 24a of the rocker arms 24, each in the direction of wall 22a of recesses 22 by a specific travel H (see FIG. 6), so that the wedging of the balls 23 between the active surface and the inner circumferential surface is definitely released. In the position shown in FIG. 5 there is a specific difference between the diameters of balls 23 and a distance between the bottom surface of the recesses and the inner circumferential wall of casing 20, so that wedging is not possible.

Now if the seal 21 rotates counterclockwise (against the tensioning direction) due to torque applied to the driveshaft, grinding or other interaction of balls 23 with active surfaces 22c will not take place.

FIG. 6 shows a detailed enlargement of one of balls 23 in its recess 22, where the dashed line shows its position in wedged position without interaction with lever element 24. The solid line shows a released position of balls 23 in accordance with FIG. 5.

FIG. 7 shows the section along line C-C in FIG. 3. The input-side shaft 18 and the output-side shaft 19 are connected to each other in this sectional plane, which lies axially on each side of the planes of the locking elements 23 and the plate shaped rocker arm 24 that is arranged in the same plane as the locking elements, by means of a form-fit interlock in a torque-locking manner. The interlock comprises a locking pin 27, which has been shifted into a drilling in head 25 and projects beyond head 25 on both sides. Locking pin 27 fits into a gap-shaped radially running slot 28 in seal 21, where an opening angle of slot 28 is a little larger than the opening angle of the locking pin 27 in the direction of rotation.

FIG. 7 shows, in the left hand and right hand views, two different stop positions of the form-fit interlock 27 and 28, for example according to different directions of rotation of the input-side driveshaft. Through the difference between the two stop positions there is a definite play of a few degrees with respect to the form-fit interlock of the input shaft 18 and the output shaft 19. This enables actuation of the lever elements 24 in correspondence with the relative rotation of head 25 of input shaft 18 relative to seal 21 of output shaft 19.

In the view on the left in FIG. 7 the locking pin 27 lies against seal 21 in the tensioning direction, so that the locking elements 23 in correspondence with FIG. 5 are in the released position. The locking coupling then is in the released position. In the view on the right in FIG. 7 the locking pin 27 lies against seal 21 against the tensioning direction, so that the locking elements 23 in correspondence with FIG. 4 can move into the wedged position. The locking coupling then is in the locked position.

The schematically represented locking coupling 17 can additionally contain washers, gaskets, or other means that are conventional for such a coupling. In particular, they can have a permanent filling with a lubricant.

The invention now operates as follows:

By rotating the input-side shaft 18 clockwise (see FIG. 5), locking coupling 17 is released by means of a specified travel of locking element 23 by rocker arm 24, after which it is taken by the stop of the form-fit interlock 27 of seals 21 and the output side shaft 19 until spring 5 is brought to a pretensioned position 5 (not shown).

In this position motor 6 is switched off and a signal from the actuation switch 4 is awaited. The locking coupling 17 prevents reverse rotation of spindle 11 against the motor 6, which no longer exerts a mechanical force. The locked position according to FIG. 4 requires that the rocker arms be able to interact by their active surfaces 24c in recesses 26 of head 25, for which an appropriate position of the input shaft and output shaft with respect to each other must be present. This can be achieved in various ways, for example by a particularly specific reverse rotation of the motor for purposes of locking the coupling, or by the appropriate shaping of the active surfaces 24c and recesses 26, back-driving springs can be provided between wall 22a and balls 23. Back-driving springs can be provided alternatively or supplementally on the rocker arms themselves as well.

If a driving operation is to take place or if switch 4 is actuated, then by rotation of the motor in the tensioning direction, spring 5 is further tensioned from the pretensioned position into the end position in accordance with FIG. 2, and the locking coupling 17 is released by rotation of head 25 clockwise, or in the tensioning direction (see FIG. 5). In an embodiment example that is not shown, the spring is already completely tensioned before actuation of the switch, so that the additional step of further tensioning is omitted. Then the bracket element 15 is released in the manner described previously by stopping against the conical surface 16a, after which spring 5 is abruptly released and the driving ram 8 with pin 8a for driving nail 10 moves forward. Afterward, the spindle is again moved in the opposite direction by rotation of motor 6 until bracket element 15 again meshes with driving ram 8 in accordance with FIG. 1.

A special characteristic exists when the fastener-driving apparatus in pretensioned position (not shown) is turned off, for example manually or by automatic switching off after a certain period of time. So that the driving apparatus is not shifted to a standby state with spring 5 tensioned, in the course of the switching-off operation spring 5 is released in a controlled way. For this, locking coupling 17 is released by the corresponding rotation of the drive-side shaft against the tensioning direction, thus clockwise, in accordance with FIG. 5, after which the motor is preferably switched off and/or, especially preferably short-circuited, in order to slow down rotation against the tensioning direction. In the case of intentional braking or braking caused by friction the motor exerts a torque in the tensioning direction on the input-side shaft 18, while the input-side shaft 18 rotates against the tensioning direction. In this state or even during a preceding or subsequent stoppage of the input-side shaft 18, the locking elements 23 are released from the wedged position.

In the released state of locking coupling 17, the coil spring 5 drives the output-side shaft 19 via spindle 11 until the spring is completely decompressed. The locking coupling 17 remains in the definitely released state, which was achieved by brief rotation of the motor against the tensioning direction, or in the drive direction. The mechanical energy of coil spring 5 is converted to heat via the motor as a generator and load resistors (not shown). Friction does not arise in locking coupling 17 or arises only to a small extent.

1. A fastener-driving apparatus comprising
a mechanical energy storage means with a tensioning device driven by a rotatable shaft, where release of the stored mechanical energy drives a driving ram,
a driving arrangement with an electric motor to introduce mechanical energy into the energy storage means by driving the shafts in a tensioning direction, and
a locking coupling arranged between the motor and the tensioning device and having an input shaft and an output shaft, where the tensioning device is kept self-locking by the locking coupling in at least one pretensioned position when the motor is shut off, and
where the locking coupling has at least one locking element that can be wedged against an active surface, and,
the locking element is releasable during a rotation of the input shaft against the tensioning direction and/or during stoppage of the input shaft in the tensioning direction of the torque-loaded input shaft from a wedged position.

2. The driving apparatus as in claim 1, wherein the locking element is releasable from the wedged position by means of a torque exerted in the tensioning direction by the input shaft.

3. The driving apparatus as in claim 1, wherein the energy storage means comprises a spring.

4. The driving apparatus as in claim 1, wherein the tensioning device comprises a spindle.

5. The driving apparatus as in claim 1, wherein the driving ram is releasable by moving the tensioning device from the pretensioned position to an end position.

6. The driving apparatus as in claim 1, wherein when the driving apparatus is shut off, a controlled untensioning of the energy storage means by movement of the motor against the tensioning direction is initiated.

7. The driving apparatus as in claim 1, wherein the locking coupling comprises at least one lever element that can be moved with respect to the input shaft and the output shaft, where one position of the locking element relative to the active surface can be changed into the wedged position and/or from the wedged position by a movement of the lever element.

8. The driving apparatus as in claim 7, wherein the lever element is a rotatably supported rocker arm.

9. The driving apparatus according to claim 7, wherein the lever element is movable by a rotation of the input shaft relative to the output shaft, where an active surface of the lever element interacts with a cam surface of the input shaft.

10. The driving apparatus as in claim 1, wherein the input shaft and the output shaft interlock with each other in a form fit interlock in the direction of rotation, where the form fit interlock has play over a defined angle of rotation.

11. The driving apparatus as in claim 10, wherein the form-fit interlock is arranged in the axial direction in a different plane from the locking element.

12. The driving apparatus of claim 3, wherein the spring comprises a coil spring.

13. The driving apparatus of claim 4, wherein the tensioning device comprises the spindle with a ball nut.

14. The driving apparatus as in claim 2, wherein the energy storage means comprises a spring.

15. The driving apparatus as in claim 2, wherein the tensioning device comprises a spindle.

16. The driving apparatus as in claim 4, wherein the tensioning device comprises a spindle.

17. The driving apparatus as in claim 12, wherein the tensioning device comprises a spindle.

18. The driving apparatus as in claim 13, wherein the driving ram is releasable by moving the tensioning device from the pretensioned position to an end position.

19. The driving apparatus as in claim 4, wherein the driving ram is releasable by moving the tensioning device from the pretensioned position to an end position.

20. The driving apparatus as in claim 2, wherein the driving ram is releasable by moving the tensioning device from the pretensioned position to an end position.
